(19) United States
(12) Patent Application Publication
(10) Pub. No.: US 2025/0353619 A1
(43) Pub. Date: Nov. 20, 2025

(54) MICROGRAVITY SIMULATION SYSTEM

(71) Applicant: The United States of America, as represented by the Secretary of Agriculture, Washington, DC (US)

(72) Inventors: YAGUANG LUO, BETHESDA, MD (US); DANIEL J. PEARLSTEIN, URBANA, IL (US)

(21) Appl. No.: 18/665,862

(22) Filed: May 16, 2024

(51) Int. Cl. B64G 7/00

(52) U.S. Cl. CPC B64G 7/00

(57) ABSTRACT

Microgravity simulation systems and methods of simulating microgravity are disclosed. This disclosure relates to a microgravity simulation system having multiple platforms, where each platform may include an outer rotating element, an inner rotating element, a sample station coupled to the inner rotating element. The microgravity simulation system may include where multiple rotating elements of each of the plurality of platforms are rotated either independently or synchronously. Furthermore, each platform of the microgravity simulation system may include a lighting element, or in particular a multi-spectral lighting element.

### FIELD

The disclosed subject matter relates generally to microgravity simulation systems and methods of simulating microgravity. Specifically, the subject matter described herein relates to microgravity simulation (MGS), and in particular to 3D clinostats, also known as random positioning machines (RPMs).

### BACKGROUND

Drop towers, such as those at NASA Glenn Research Center, and airplanes flying parabolic trajectories, have played a prominent role in MGS for a number of physicochemical phenomena, but the experimental duration, in which an experimental package falls vertically in a nearly evacuated shaft, is far too short (e.g., less than 6 seconds in a drop tower, and 22 seconds for parabolic flights) to be useful for many biological studies.

Clinostats and RPMs have been used in MGS in a broad range of space biology, biomedical, and agricultural studies, with rotation being used to simulate the effects of “microgravity” on the growth and/or behavior of plants or biological samples. Microgravity may be referred to as the condition in which people or objects appear to be weightless, or the condition where gravity seems to be very small. Microgravity is sometimes called “zero gravity,” but this can be misleading, as true zero gravity would be an absence of gravity. The effects of microgravity can be seen when astronauts and objects float in space. Microgravity can be experienced in other ways, as well. Even far from planetary bodies, residual “g-jitter” due to small accelerations of the spacecraft attributable to, for example, human motion or attitude thrusters, can have effects on biological and other processes.

In a clinostat the sample is rotated to attempt to generate a gravitational environment that approximates a zero-gravity or microgravity environment. The biological samples are rotated to produce a gravitational acceleration vector whose time-averaged value in the rotating reference frame of the sample is zero, with an overall acceleration vector either zero or close to zero. Clinostats are available in two-dimensional (2D) configurations, with a single axis of rotation, and three-dimensional (3D) configurations, with two-axes of rotation. 3D clinostats generally can provide better microgravity simulation than is possible with 2D clinostats.

The main premise of a 3D clinostat for microgravity simulation is that via rotation about two axes, the gravitational acceleration vector experienced by an object on the platform will have a time-averaged magnitude, in the platform-fixed, rotating reference frame, that is effectively zero. The instantaneous magnitude of this vector is one g at all times, but when the direction is appropriately varied in time, the time averaged magnitude of the vector can be precisely reduced or driven to zero g. The overall acceleration vector (which acts on the biological sample in the same way that gravity does in a nonrotating system) will have a time-average that departs from zero due to centrifugal effects, which are zero for samples located precisely at the intersection of the two axes of rotation. While gravitational effects may still be present in the sample, the goal is for the gravitational effect to have no net direction.

Space biology research often requires multiple platforms to allow evaluation of multiple treatments, replications, or sample compartmentation under identical microgravity and environmental conditions (such as light, temperature, humidity, or atmospheric composition) simultaneously. However, technologies or devices available today do not have this capability. To attempt to alleviate this problem, researchers may subdivide a single-platform clinostat into sub-units. However, because two subunits on a single platform cannot both be at the intersection of the rotational axes, the time-averaged overall acceleration will necessarily have a nonzero centrifugal contribution, which can confound the results and lead to incorrect conclusions. This problem cannot be mitigated by placing multiple samples equidistant from the intersection of the rotational axes. This problem is most serious for large samples and high rotation rates, where the overall acceleration experienced by parts of a single sample will depend on the distance of each part from the point of intersection of the rotational axes. Therefore, there are fundamental and significant limitations of current systems designs that cannot be overcome by subdividing a single-platform 3D clinostat.

Additionally, many space biology studies require different treatment environments (e.g., temperature, humidity, carbon dioxide (CO₂), and light) under the same simulated microgravity condition. This is not possible using a single subdivided random positioning machine (RPM). Running multiple 3D clinostats (with samples on each platform located at the intersection of the rotational axes of that platform) does not solve this issue, as no prior system in the art has the capability to adequately match two-axis platform rotation across multiple devices.

Space farming is an essential component of a bioregenerative life support system for deep space missions. Significant advancements in farming and food production systems suited to the extremely challenging microgravity environments of spaceflight will be required to feed and nourish astronauts during long-duration missions to Mars. It is thus important to understand the growth of edible plants in the microgravity environment long before launch (i.e., by studies in simulated microgravity environments on Earth).

While the existing microgravity simulators and clinostats are useful to a degree, they still suffer from certain limitations. Therefore, there exists a need in the art for an improved microgravity simulator, clinostat, or random position machine that solves or at least alleviates some or all of these problems.

### SUMMARY OF THE EMBODIMENTS

Systems and methods for simulating microgravity are disclosed and claimed herein.

As described more fully below, the devices and processes of the embodiments disclosed permit improved systems and methods for simulating microgravity. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, a microgravity simulation system is provided, the microgravity simulation system comprising a plurality of platforms, each platform comprising an outer rotating element having a first end opposite a second end, the outer rotating element having a first axis extending along a length from the first end to the second end, wherein the outer rotating element is configured to rotate about the first axis; an inner rotating element having a second axis perpendicular to the first axis of the outer rotating element, the inner rotating element configured to rotate about the second axis; wherein the inner rotating element is disposed in an interior volume delimited by the outer rotating element when the outer rotating element rotates around the first axis; wherein the outer rotating elements of each of the plurality of platforms are rotated by a single outer rotating element motor.

In various embodiments, the plurality of platforms are capable of operating synchronously. In some embodiments, the plurality of platforms are capable of rotating at the same time. In certain embodiments, the plurality of platforms are capable of rotating at the same rate of rotation. In other embodiments, the plurality of platforms are capable of operating independently of each other. In some embodiments, a first sample station is connected to the inner rotating element; wherein a rotation of the outer rotating element and the inner rotating element is capable of generating a simulated microgravity effect in the first sample station.

In certain embodiments, the inner rotating elements of each of the plurality of platforms are rotated by a single motor shared by the inner rotating elements. In another embodiment, each of the inner rotating elements of each of the plurality of platforms are rotated by a different motor.

In some embodiments, the plurality of platforms are located on a stand that supports the plurality of platforms. In various embodiments, a six degree-of-freedom inertial measurement unit is disposed on the sample station.

In certain embodiments, the first sample station extends perpendicular to the second axis of the inner rotating element. In various embodiments, the first sample station is located toward a first side of the inner rotating element, and a second plate is located toward a second side of the inner rotating element, wherein the first side is opposite the second side. In some embodiments, the second plate has at least one lighting element. In certain embodiments, the at least one lighting element is a multi-spectral lighting element. In various embodiments, the multi-spectral lighting element comprises a plurality of lights, the plurality of lights comprising at least a first light and a second light; wherein the first light is a different color from the second light.

In some embodiments, the microgravity simulation system further comprises a frame supporting the plurality of platforms; an outer rotating element motor operatively connected to an outer rotating element drive shaft; a first drive chain operatively connected to the outer rotating element drive shaft; and a first outer rotating element axle operatively connected to the first drive chain; wherein the first outer rotating element axle is operatively connected to at least one of the outer rotating elements.

In certain embodiments, the microgravity simulation system further comprises an inner rotating element motor operatively connected to an inner rotating element drive shaft; an inner rotating element transfer shaft operatively connected to the inner rotating element drive shaft by an inner axle drive chain; a floating double sprocket operatively connected to the inner rotating element transfer shaft by a transfer shaft drive chain; a gearbox having a gearbox input shaft and a gearbox output shaft, the gearbox input shaft operatively connected to the floating double sprocket by a double sprocket drive chain; and an inner frame axle operatively connected to the inner rotating element, wherein the gearbox is operatively connected to the inner frame axle by a gearbox drive chain.

In one form, the present disclosure provides a microgravity simulation device, comprising: a first rotatable element, having a first sample station; a second rotatable element, having a second sample station; and a first motor operatively connected to the first rotatable element; wherein the first rotatable element and the second rotatable element are capable of rotating synchronously. In some embodiments, a second motor is operatively connected to the second rotatable element.

In certain embodiments, the first motor is operatively connected to both the first rotatable element and the second rotatable element such that the first rotatable element and second rotatable element are capable of rotating synchronously. In various embodiments, the first rotatable element is a first inner rotatable element, and the second rotatable element is a second inner rotatable element; and the first motor is operatively connected to both the first inner rotatable element and the second inner rotatable element such that the first inner rotatable element and second inner rotatable element are capable of rotating synchronously.

In some embodiments, the first inner rotatable element is coupled to a first outer rotatable element, and the second inner rotatable element is coupled to a second outer rotatable element; wherein the inner rotatable element is disposed in an interior volume delimited by a rotation of the outer rotatable element. In certain embodiments, a second motor is operatively connected to both the first outer rotatable element and the second outer rotatable element such that the first outer rotatable element and second outer rotatable element are capable of rotating synchronously.

In one form, the present disclosure provides a method of simulating microgravity, comprising: rotating an outer rotating element of each of a plurality of platforms of a microgravity simulation device; and rotating an inner rotating element of each of the plurality of platforms, wherein the inner rotating element is disposed in an interior volume delimited by a rotation of the outer rotatable element; and wherein a simulated microgravity effect is generated in a sample station of each of the plurality of platforms.

In some embodiments, the outer rotating element of each of a plurality of platforms rotate synchronously. In certain embodiments, the inner rotating element of each of a plurality of platforms rotate at the same rate of rotation. In various embodiments, the microgravity simulation device is capable of generating the same microgravity effect in a sample station of each of the inner rotating elements. In certain embodiments, the microgravity simulation device further comprises at least one lighting element. In some embodiments, the wherein the at least one lighting element is a multi-spectral lighting element. In certain embodiments, the outer rotating element of each of a plurality of platforms is rotated by a first motor shared among each of the outer rotating elements such that the first motor rotates each of the outer rotating elements synchronously; and wherein the inner rotating element of each of the plurality of platforms is rotated by a second motor shared among each of the inner rotating elements such that the second motor rotates each of the inner rotating elements synchronously.

These and other objects, features, aspects, and advantages of the present patent document will become better understood with reference to the following description and accompanying drawings.

### BRIEF DESCRIPTION OF THE DRAWINGS

FIG. 1 illustrates a front view of a preferred embodiment of a microgravity simulation system of the present patent document.

FIG. 2 illustrates a side cross-sectional view of a drive system of the embodiment shown in FIG. 1.

FIG. 3 illustrates a front view of an alternative embodiment of a microgravity simulation system of the present patent document.

FIG. 4 illustrates a side view of an alternative embodiment of a platform of a microgravity simulation system of the present patent document.

FIG. 5 illustrates a side view of an alternative embodiment of a platform of a microgravity simulation system of the present patent document.

FIG. 6 illustrates a top view of an embodiment of a lighting system of a microgravity simulation system of the present patent document.

FIG. 7 illustrates a process for simulating microgravity in accordance with a preferred embodiment of the present patent document.

FIG. 8 illustrates a perspective view of an embodiment of a microgravity simulation system of the present patent document with multiple platforms.

FIG. 9 illustrates a side view of an alternative embodiment of a platform of a microgravity simulation system of the present patent document.

Note that assemblies/systems in some of the FIGs. may contain multiple examples of essentially the same component. For simplicity and clarity, only a small number of the example components may be identified with a reference number. Unless otherwise specified, other non-referenced components with essentially the same structure as the exemplary component should be considered to be identified by the same reference number as the exemplary component. Further, unless specifically indicated otherwise, drawing components may or may not be shown to scale.

### DETAILED DESCRIPTION OF PREFERRED EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

In accordance with the present disclosure, improved microgravity simulation devices and methods are disclosed which address, or at least ameliorate one or more of the problems of existing designs.

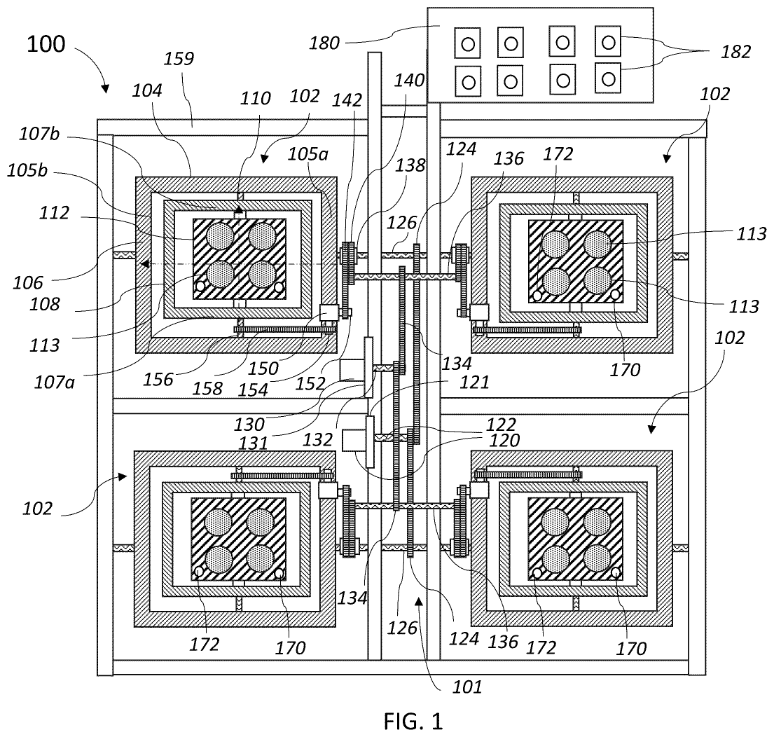

Referring to FIG. 1, there is shown a front view of a preferred embodiment of a microgravity simulation system 100 of the present patent document. In a preferred embodiment, a microgravity simulation system 100 includes a plurality of platforms 102, where each platform 102 includes an outer rotating element 104 having a first end 105a opposite a second end 105b, where the outer rotating element 104 has a first axis 106 extending along a length from the first end 105a to the second end 105b. The outer rotating element 104 may be configured to rotate about the first axis 106. For example, an outer rotating element axle 126 extending along the first axis 106 may be fixedly mounted to the outer rotating element 104 and supported for rotation on a stand 159 using one or more conventional rotation supporting devices, such as a plurality of bearing assemblies (not shown). An inner rotating element 108 may have a second axis 110 perpendicular to the first axis 106 of the outer rotating element 104, where the inner rotating element 108 has a first end 107a opposite a second end 107b. In such embodiments, the inner rotating element 108 has a second axis 110 extending along a length from the first end 107a to the second end 107b, wherein the inner rotating element 108 may be configured to rotate about the second axis 110. For example, an inner frame axle 156 extending along the second axis 110 may be fixedly mounted to the inner rotating element 108 and supported for rotation on the outer rotating element 104 using one or more conventional rotation supporting devices, such as a pair of bearing assemblies (not shown) The inner rotating element 108 may be disposed in an interior volume delimited by the outer rotating element 104 when the outer rotating element 104 rotates around the first axis 106. In various embodiments, a sample station 112 may be couped to the inner rotating element 108. In certain embodiments, the sample station 112 may be fixedly connected to the inner rotating element 108. In some embodiments, the sample station 112 may include samples 113 disposed on the surface of sample station 112. In certain embodiments, rotating elements (e.g., outer rotating element 104, and inner rotating element 108) may also be referred to as rotatable elements.

In some embodiments, each of the outer rotating elements 104 of each of the plurality of platforms 102 may be rotated by a single outer rotating elements motor 120. In such embodiments, the outer rotating elements 104 may be capable of operating synchronously. In certain embodiments, the inner rotating elements 108 of each of the plurality of platforms may be rotated by a single inner rotating element motor 130 shared by the inner rotating elements 108. The rotation of the outer rotating element 104 and the inner rotating element 108 may be capable of generating a simulated microgravity effect in the sample station 112. In some embodiments, the plurality of platforms 102 may be capable of operating synchronously. In other embodiments, the plurality of platforms 102 may be capable of operating independently of each other. In some embodiments, the plurality of platforms 102 may be capable of operating at the same time. In various embodiments, the outer rotating elements 104 may be capable of operating synchronously. In certain embodiments, the inner rotating elements 108 may be capable of operating synchronously. In various embodiments, the outer rotating elements 104 may be capable of operating at the same time. In certain embodiments, the inner rotating elements 108 may be capable of operating at the same time. In some embodiments, the outer rotating elements 104 may be capable of rotating at the same rate of rotation. In certain embodiments, the inner rotating elements 108 may be capable of rotating at the same rate of rotation. The plurality of platforms 102 may be located on a stand 159 that supports the plurality of platforms 102.

In various embodiments, a first sample station 112 may extend parallel to the second axis 110 of the inner rotating element 108. In certain embodiments, the sample station 112 may be located parallel to the second axis 110 and perpendicular to the inner rotating element 108. In other embodiments, the sample station 112 may be disposed at any location or orientation coupled to the inner rotating element 108 as desired. In a preferred embodiment, a sample placed at a given point on one platform will experience the same acceleration history as a sample placed at a corresponding point on a different platform. For example, in a preferred embodiment of the microgravity simulation system 100, a sample placed at the center of a first sample station 112 of a first platform 102 will experience the same gravitational effects as a sample placed at the center of a second sample station 112 of a second platform 102.

In various embodiments, a microgravity simulation system may include a microgravity monitoring system. A microgravity monitoring system may include an inertial measurement unit 170. In an example embodiment, the inertial measurement unit 170 may be a six degree-of-freedom inertial measurement unit. A six degree-of-freedom inertial measurement unit 170 may be installed on a sample station 112. In an example embodiment, an output of an inertial measurement unit may be used to calculate the instantaneous and time-averaged acceleration vector and a simulated microgravity. Inertial measurement unit 170 may be connected to a computing device (not shown) using, for example, wires (not shown) routed through slip ring connectors (not shown). Alternatively, inertial measurement unit 170 may be connected to the computing device wirelessly.

In certain embodiments, the microgravity simulation system 100 may include a stand 159 that supports the plurality of platforms 102, and an outer rotating element motor 120 operatively connected to an outer rotating element drive shaft 122. A first drive chain 124 may be operatively connected to the outer rotating element drive shaft 122. An outer rotating element axle 126 may be operatively connected to the first drive chain 124, where the outer rotating element axle 126 is operatively connected to at least one of the outer rotating elements 104.

In some embodiments, the microgravity simulation system 100 may include an inner rotating element motor 130 operatively connected to an inner rotating element drive shaft 132. An inner rotating element transfer shaft 136 may be operatively connected to the inner rotating element drive shaft 132 by an inner axle drive chain 134. A floating double sprocket 138 may be operatively connected to the inner rotating element transfer shaft 136 by a transfer shaft drive chain 140. A gearbox 150 may have a gearbox input shaft 152 and a gearbox output shaft 154, where the gearbox input shaft 152 may be operatively connected to the floating double sprocket 138 by a double sprocket drive chain 142. The gearbox 150 may be operatively connected to the inner frame axle 156 by a gearbox drive chain 158, where the inner frame axle 156 may be operatively connected to the inner rotating element 108.

In some embodiments, the outer rotating elements motor 120 may be coupled to an outer rotating elements motor plate 121 to support the outer rotating elements motor 120, where the outer rotating elements motor plate 121 may be coupled to the stand 159. The inner rotating elements motor 130 may be coupled to an inner rotating elements motor plate 131 to support the inner rotating elements motor 130, where the inner rotating elements motor plate 131 may be coupled to the stand 159.

In various embodiments, a controller plate 180 may be coupled to the stand 159, where the controller plate 180 may have one or more controllers 182. A controller 182 may be in electrical communication with one or more motors. The controller 182 may be configured to transmit control signals to the motor to control the operation of the motor. For example, a controller 182 may be in electrical communication with an outer rotating elements motor 120, and another controller 182 may be in electrical communication with an inner rotating elements motor 130. In such an embodiment, one controller 182 may be configured to transmit control signals to the outer rotating elements motor 120 to control the operation of the outer rotating elements motor 120, and a different controller 182 may be in electrical communication with an inner rotating elements motor 130 to control the operation of the inner rotating elements motor 130. In certain embodiments, electrical communication may be by wires or other conductive elements. In other embodiments, electrical communication may be wireless.

In some embodiments, one controller 182 may be configured to transmit control signals to an outer rotating elements motor 120 to control the operation of an outer rotating elements motor 120, where the outer rotating elements motor 120 rotates at least one of the outer rotating elements 104. For example, one outer rotating elements motor 120 may be capable of rotating more than one outer rotating elements 104 synchronously. In some embodiments, synchronization between the outer rotating elements 104 may be achieved mechanically by sharing the power output from the same outer rotating elements motor 120. Synchronization between the outer rotating elements 104 may be achieved mechanically by sharing the torque from the same outer rotating elements motor 120.

In certain embodiments, a first controller 182 may be in electrical communication with the outer rotating element motor 120, where the outer rotating elements motor 120 may be operatively connected to the outer rotating element 104, and a second controller 182 may be in electrical communication with the inner rotating element motor 130, where the inner rotating elements motor 130 may be operatively connected to the inner rotating element 108. In such an embodiment, the first controller 182 may be capable of controlling the rotation of the outer rotating element 104 and the second controller 182 may be capable of controlling the inner rotating element 108 such that the outer rotating element 104 and inner rotating element 108 are capable of operating synchronously. In certain embodiments, the first controller 182 may be capable of controlling the rotation of the outer rotating element 104 and the second controller 182 may be capable of controlling the inner rotating element 108 such that the outer rotating element 104 and inner rotating element 108 are capable of operating at the same rate of rotation.

In some embodiments, the platforms 102 may be driven by motors controlled with dial-operated pulse-width modulation (PWM) dimmers to set their speeds. The motor controllers may be digital programmable controllers that can perform continuous modulation of frame rotation speeds. In some embodiments, each motor may be driven by a low cost dial-operated PWM controller that determines the speed of each motor. In other embodiments, the controllers may be more sophisticated controllers that can adjust speed and reverse motor direction, thus allowing for better random motion.

One or more accelerometers 172 may be placed on portions of the microgravity system 100, where the accelerometers output data that may be used to adjust frame rotation speeds in real-time to simulate microgravity conditions more precisely. The accelerometers 172 may be connected to one or more of the controllers 182 using, for example, wires (now shown) routed through slip ring connectors (not shown). Alternatively, the accelerometers 172 may be connected to one or more of the controllers 182 wirelessly. Accelerometers 172 may be connected to a computing device (not shown) using, for example, wires (not shown) routed through slip ring connectors (not shown). Alternatively, accelerometers 172 may be connected to the computing device wirelessly.

In various embodiments, the motors may be electric motors. For example, the outer rotating elements motor 120 and the inner rotating elements motor 130 may be electric motors. In such embodiments, the motors may be electrically connected to an electric power source (not shown), such as an electrical outlet. The outer rotating elements motor 120 and the inner rotating elements motor 130 may be powered and/or connected to one or more controllers 182 using, for example, wires (not shown) routed through slip ring connectors (not shown).

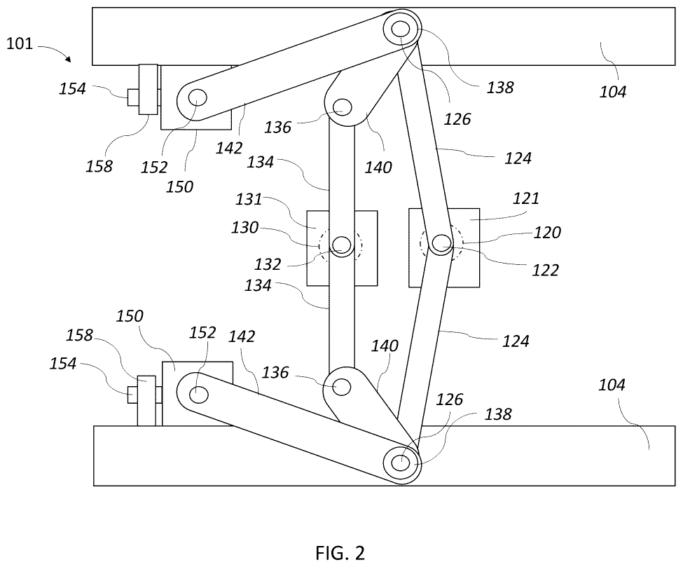

Referring to FIG. 2, there is shown a side cross-sectional view of a drive system 101 of the embodiment of the microgravity simulation system 100 shown in FIG. 1. The drive system 101 shown in FIG. 2 includes an outer rotating elements motor 120 and an inner rotating elements motor 130. The outer rotating elements motor 120 may be operatively connected to an outer rotating element drive shaft 122. A first drive chain 124 may be operatively connected to the outer rotating element drive shaft 122. An outer rotating element axle 126 may be operatively connected to the first drive chain 124, where the outer rotating element axle 126 may be operatively connected to at least one of the outer rotating elements 104. The inner rotating element motor 130 may be operatively connected to an inner rotating element drive shaft 132. An inner rotating element transfer shaft 136 may be operatively connected to the inner rotating element drive shaft 132 by an inner axle drive chain 134. A floating double sprocket 138 may be operatively connected to the inner rotating element transfer shaft 136 by a transfer shaft drive chain 140. A gearbox 150 may have a gearbox input shaft 152 and a gearbox output shaft 154, where the gearbox input shaft 152 may be operatively connected to the floating double sprocket 138 by a double sprocket drive chain 142. An inner frame axle 156 (not shown in FIG. 2) may be operatively connected to the inner rotating element 108 (not shown in FIG. 2), where the gearbox 150 may be operatively connected to the inner frame axle 156 by a gearbox drive chain 158.

In an embodiment shown in FIG. 2, the outer rotating elements motor 120 rotates the outer rotating element drive shaft 122. The outer rotating element drive shaft 122 and first drive chains 124 transfer power from the outer rotating elements motor 120 to the outer rotating element axles 126. The outer rotating elements 104 may be coupled to the outer rotating element axles 126 such that power is transferred from the outer rotating elements motor 120 to rotate the outer rotating elements 104.

In an embodiment shown in FIG. 2, the inner rotating elements motor 130 rotates the inner rotating element drive shaft 132. The inner rotating element drive shaft 132 and inner axle drive chains 134 transfer power from the inner rotating elements motor 130 to the inner rotating element transfer shafts 136. The inner rotating element transfer shafts 136 rotate the transfer shaft drive chains 140, such that the transfer shaft drive chains 140 then rotate the floating double sprockets 138. A floating double sprocket 138 may be coupled to the outer rotating element axle 126 such that floating double sprocket 138 rotates freely around the outer rotating element axle 126. The floating double sprockets 138 then rotate the double sprocket drive chains 142 such that the double sprocket drive chains 142 then rotate the gearbox input shafts 152. The gearbox input shafts 152 then rotate gears in the gearboxes 150 such that the gearboxes 150 transfer power to the gearbox output shafts 154. The gearbox output shafts 154 rotate the gearbox drive chains 158 such that the gearbox drive chains 158 rotate the inner frame axles 156 (not shown in FIG. 2). The inner frame axles 156 may be coupled to the inner rotating elements 108 such that power is transferred from the inner rotating elements motor 130 to rotate the inner rotating elements 108 (not shown in FIG. 2).

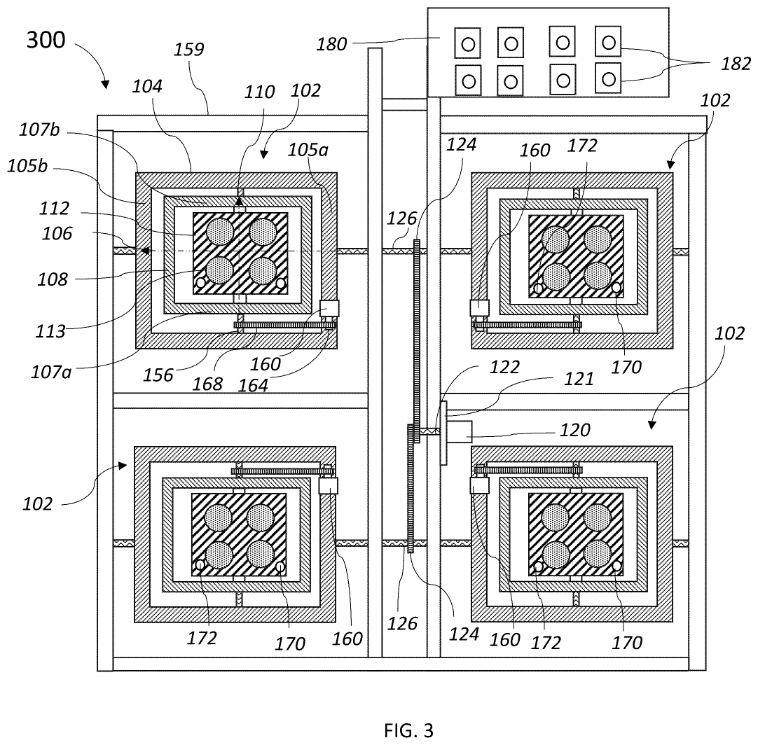

Referring to FIG. 3, there is shown a front view of an alternative embodiment of a microgravity simulation system of the present patent document. In the embodiment shown in FIG. 3 of the microgravity simulation system 300, each of the inner rotating elements 108 of each of the plurality of platforms 102 may be rotated by a different motor. The microgravity simulation system 300 may include an outer rotating element motor 120, where the outer rotating element motor 120 may be used to rotate multiple outer rotating elements 104. As seen in FIG. 3, the microgravity simulation system 300 may include multiple inner rotating element motors 160. The inner rotating element motors 160 may be powered and/or connected to one or more controllers 182 using, for example, wires (not shown) routed through slip ring connectors (not shown). In some embodiments, the inner rotating element motors 160 may be installed on the outer rotating element 104. In the embodiment shown in FIG. 3, each of the inner rotating elements 108 of each of the plurality of platforms 102 may be rotated by a different inner rotating element motor 160. The inner rotating element motor 160 may have a motor output shaft 164, where the inner rotating element motor 160 may be operatively connected to the inner frame axle 156 by an inner rotating element motor drive chain 168. The inner frame axle 156 may be operatively connected to the inner rotating element 108, where the inner rotating element motor 160 is capable of rotating the inner rotating element 108.

In some embodiments, one or more controllers 182 may be configured to transmit control signals to one or more inner rotating element motors 160 to control the operation of the inner rotating element motors 160, where each of the inner rotating element motors 160 rotates an outer rotating element 104. For example, one controller may control one inner rotating element motor 160, and a separate controller may control another inner rotating element motor 160, such that each of the inner rotating elements 108 may be capable of rotating synchronously by action of the controller signals from each of the controllers 182. In such embodiments, the synchronization of the inner rotating elements 108 may be achieved electrically by using one or more controllers 182 to control one or more inner rotating element motors 160 to achieve the same rate of rotation between one or more inner rotating elements 108.

In various embodiments, a microgravity simulation system may include a microgravity monitoring system. A microgravity monitoring system may include an inertial measurement unit 170. In an example embodiment, the inertial measurement unit 170 may be a six degree-of-freedom inertial measurement unit. A six degree-of-freedom inertial measurement unit 170 may be installed on a sample station 112. In an example embodiment, an output of an inertial measurement unit may be used to calculate the instantaneous and time-averaged acceleration vector and a simulated microgravity. Inertial measurement unit 170 may be connected to a computing device (not shown) using, for example, wires (not shown) routed through slip ring connectors (not shown). Alternatively, inertial measurement unit 170 may be connected to the computing device wirelessly.

In some embodiments, the platforms 102 may be driven by motors controlled with dial-operated pulse-width modulation (PWM) dimmers to set their speeds. The motor controllers may be digital programmable controllers that can perform continuous modulation of frame rotation speeds. In some embodiments, each motor may be driven by a low cost dial-operated PWM controller that determines the speed of each motor. In other embodiments, the controllers may be more sophisticated controllers that can adjust speed and reverse motor direction, thus allowing for better random motion.

One or more accelerometers 172 may be placed on portions of the microgravity system 300, where the accelerometers' output data may be used to adjust frame rotation speeds in real-time to simulate microgravity conditions more precisely. The accelerometers 172 may be connected to one or more of the controllers 182 using, for example, wires (not shown) routed through slip ring connectors (not shown). Alternatively, the accelerometers 172 may be connected to one or more of the controllers 182 wirelessly. Accelerometers 172 may be connected to a computing device (not shown) using, for example, wires (not shown) routed through slip ring connectors (not shown). Alternatively, accelerometers 172 may be connected to the computing device wirelessly.

In various embodiments, the motors may be electric motors. For example, the outer rotating elements motor 120 and the inner rotating element motors 160 may be electric motors. In such embodiments, the motors may be electrically connected to an electric power source (not shown), such as an electrical outlet.

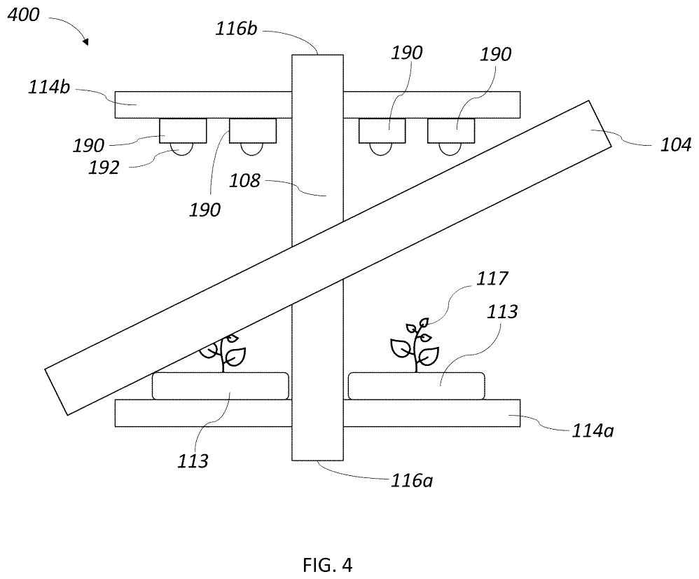

Referring to FIG. 4, there is shown a side view of an alternative embodiment of a platform of a microgravity simulation system of the present patent document. In the platform 400 shown in FIG. 4, each internal rotating element 108 has two sample plates installed facing each other across the rotational axis of the internal rotating element 108. In some embodiments, a sample station may be referred to as a sample plate. A first sample plate 114a may have samples to be tested, and a second sample plate 114b may have a light-emitting diode (LED) light panel to illuminate the samples on sample plate 114a. A lighting system may include lighting elements 190. A first sample plate 114a may be located toward a first side 116a of the inner rotating element 108, and a lighting plate 114b may be located toward a second side 116b of the inner rotating element, where the first side 116a is opposite the second side 116b. In some embodiments, the lighting plate 114b may have at least one lighting element 190. The lighting plate 114b may have at least one lighting element 190 with lights 192 capable of illuminating samples 113 on the first sample plate 114a. The at least one lighting element 190 with lights 192 may be powered and/or connected to one or more controllers (e.g., 182, shown in FIGS. 1 and 3) using, for example, wires (now shown) routed through slip ring connectors (not shown).

Alternatively, the at least one lighting element 190 with lights 192 may be connected to the one or more controllers wirelessly. In a preferred embodiment, the microgravity system 100 is capable of rotating the plurality of platform 102 and illuminating the samples 113 simultaneously. In an example embodiment, the sample plates may be 12″×12″, however any suitable dimensions may be used. In certain embodiments, a sample 113 may be a petri dish that may contain biological material. In other embodiments, a sample 113 may have a plant 117. In some embodiments, a sample 113 may have more than one plant 117. In other embodiments, a sample 113 maybe be placed at the center of the sample station 112.

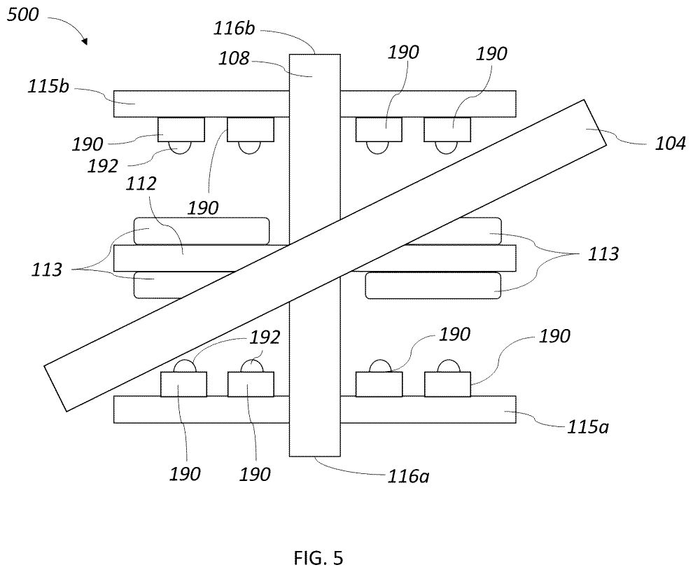

Referring to FIG. 5, there is shown a side view of an alternative embodiment of a platform of a microgravity simulation system of the present patent document. In the platform 500 shown in FIG. 5, a sample station 112 may be stationed in the center of inner rotating element 108 with lights illuminating samples on the sample station 112. A first lighting plate 115a may be located toward a first side 116a of the inner rotating element 108, and a second lighting plate 115b may be located toward a second side 116b of the inner rotating element 108, where the first side 116a is opposite the second side 116b. In some embodiments, a sample station 112 may be located in the center inner rotating element 108. In other embodiments, a sample station 112 may be located in any location of the inner rotating element 108 as desired. In certain embodiments, a sample 113 may be located in the center of the sample station 112. In other embodiments, a sample 113 may be located on any location of the sample station 112 as desired. In some embodiments, a sample 113 may be placed at the center of the sample station 112 on both sides of the sample station 112. In some embodiments, the first lighting plate 115a and second lighting plate 115b may each have at least one lighting element 190 with lights 192 capable of illuminating samples 113 on the sample plate 112. The lighting plates (115a, 115b) may have any number of lighting elements 190 in any configuration as desired. Here too, each of the at least one lighting element 190 with lights 192 may be powered and/or connected to one or more controllers (e.g., 182 shown in FIGS. 1 and 3) using, for example, wires (not shown) routed through slip ring connectors (not shown). Alternatively, each of the at least one lighting element 190 with lights 192 may be connected to the one or more controllers wirelessly.

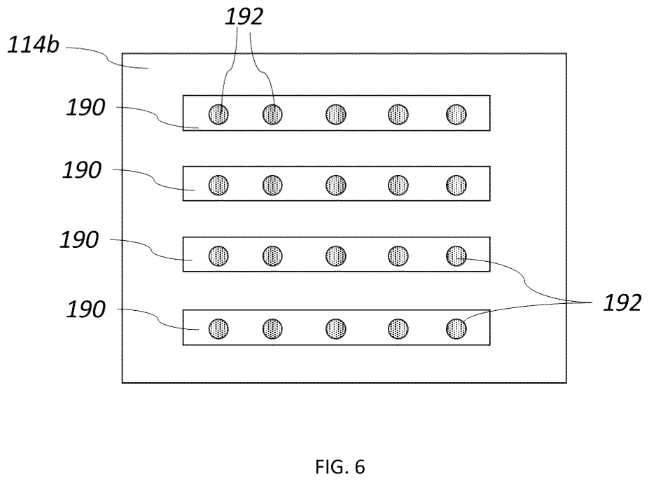

Referring to FIG. 6, there is shown a top view of an embodiment of a lighting plate 114b of a microgravity simulation system of the present patent document. In some embodiments, the lighting plate 114b may have at least one lighting element 190. The lighting plate 114b may have at least one lighting element 190 with lights 192 capable of illuminating samples on a sample plate. The lighting element 190 may include one or more lights 192. The lighting element 190 may have any number of lights 192 in any configuration as desired. The lighting plate 114b may have any number of lighting elements 190 in any configuration as desired.

In various embodiments, the lighting element 190 may be a multi-spectral lighting element. A multi-spectral lighting element may comprise one or more lights, where the lights may produce different colors. For example, one lighting element 190 may contain lights 192 that are white, and another lighting element 190 may contain lights 192 that are blue. In another example embodiment, one lighting element 190 may contain lights 192 that are white, a second lighting element 190 may contain lights 192 that are blue, a third lighting element 190 may contain lights 192 that are red, and fourth lighting element 190 may contain lights 192 that are yellow. In other embodiments, lights 192 within one light bar may be different colors. For example, a lighting element 190 may have at least one light 192 that is white, and another light 192 that is blue. In another example, a light bar 190 may have one light 192 that is white, one light 192 that is blue, one light 192 that is yellow, and one light 192 that is red. In some embodiments, the lights 192 may be any color as desired, such as, but not limited to, white, blue, red, yellow, green, and magenta. In some embodiments, lights 192 may comprise one or more lights of different wavelengths, such as violet (380-450 nm), blue (450-495 nm), green (495-570 nm), yellow (570-590 nm), orange (590-620 nm), red (620-750 nm), or white (380-760 nm). These examples are for illustrative purposes only and any other combinations of lights, light configurations, color, or wavelength configurations may be used as desired.

A light 192 may be an LED or a series of LEDs. In certain embodiments, the lighting elements 190 may be referred to as light bars. In various embodiments, the lighting elements 190 or lights 192 may be electrically connected to an electric power source (not shown), such as an electrical outlet. In some embodiments, the lighting elements 190 or lights 192 may be operatively connected to a controller (e.g., 182 in FIGS. 1 and 3) capable of controlling various lighting parameters including, but not limited to, lighting activation/deactivation timing, lighting wavelength, and lighting intensity.

In some embodiments, the microgravity simulation system may have a modular lighting system in which each light panel has a set of powered sockets to accept light bars, where the light bars may have one or more sets of LEDs wired in series with integrated resistors to set proper current for the LED chips. In a certain embodiment, the lighting system may have interchangeable lights. For example, this configuration can allow for the “hot-swapping” of lights, where the light bars with different spectra can be swapped in and out with minimal or no interruption to the microgravity simulation system operation. In such embodiments, the voltage supplied to the sockets on the lighting panels may also be controlled by PWM dimmers, allowing for the adjustment of the light intensity.

In certain embodiments, a microgravity simulation system may be equipped with tunable multi-spectral lighting, attached to two lighting plates attached to each inner frame parallel to, equidistantly from, and facing the sample plate. In one embodiment, a “hot-swappable” lighting system may be used where on each lighting plate, multiple interchangeable strips are installed, each with a linear array of permanently bonded LED chips. The interchangeable strips may be made of any suitable material. In one embodiment, the interchangeable strips are made of an aluminum alloy. The interchangeable strips may support the LED chips, and serve to remove residual heat. The chips on each strip may be wired in series with a resistor sized to draw the correct current, given the common voltage supplied to all of the strips. In certain embodiments, the electrical supply to each lighting platform may be filtered through a PWM dimmer to allow control of that strip's intensity. In some embodiments, the strips can be quickly changed, so that the spectral characteristics of light delivered to a sample can be changed with minimal disruption. In various embodiments, such configurations can allow for a low-cost and user-friendly way to provide any spectral combination, regardless of currently available light panels. In other embodiments, the light panels may be outfitted with multi-channel tunable lighting fixtures to allow for more precise and uniform control of lighting conditions on the sample platforms.

In a preferred embodiment, since specimens rotate inside the microgravity simulation system, it may be preferred that light panels are installed on the platforms such that the light panels rotate with the sample being illuminated. In such embodiments, the light panels rotate with the sample, so that the orientation of the incident light on the sample is time-invariant. Light modulation can be important in space farming and biology research. Plants are responsive to both gravity and light. The independent and combined effects of changes in gravity and light can be important considerations of space farming research. Effects of light wavelength, intensity, and unsteadiness (on time scales ranging from seasonal, to diurnal, to cloud-passage, to high-frequency artificial modulation with frequencies ranging, for example, from 1 Hz to MHz) are important considerations for terrestrial and space biology.

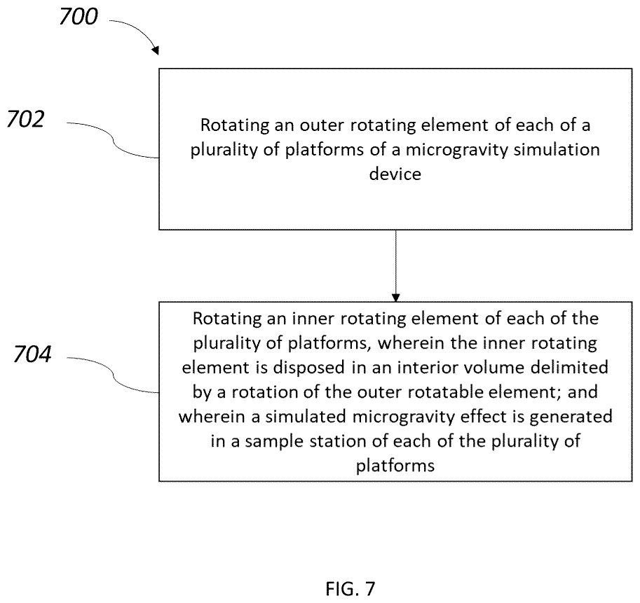

Referring to FIG. 7, an embodiment of a method 700 is shown. FIG. 7 illustrates an embodiment of a method 700 for simulating microgravity. Step 702 comprises rotating an outer rotating element of each of a plurality of platforms of a microgravity simulation device. In some embodiment the method 700 may include rotating an outer rotating element of each of a plurality of platforms of a microgravity simulation device such that each of the outer rotating elements rotate synchronously. Step 704 comprises rotating an inner rotating element of each of the plurality of platforms, wherein the inner rotating element is disposed in an interior volume delimited by a rotation of the outer rotatable element; and wherein a simulated microgravity effect is generated in a sample station of each of the plurality of platforms. In certain embodiments, the method 700 may include rotating an inner rotating element of each of the plurality of platforms such that each of the inner rotating elements rotate synchronously, wherein a simulated microgravity effect is generated in a sample station of each of the plurality of platforms. In certain embodiments of the method 700, the outer rotating element of each of a plurality of platforms is rotated by a first motor shared among each of the outer rotating elements such that the first motor rotates each of the outer rotating elements synchronously. In some embodiments of the method 700, the inner rotating element of each of the plurality of platforms is rotated by a second motor shared among each of the inner rotating elements such that the second motor rotates each of the inner rotating elements synchronously. In various embodiments of method 700, a simulated microgravity effect is generated in a sample station of each of the plurality of platforms.

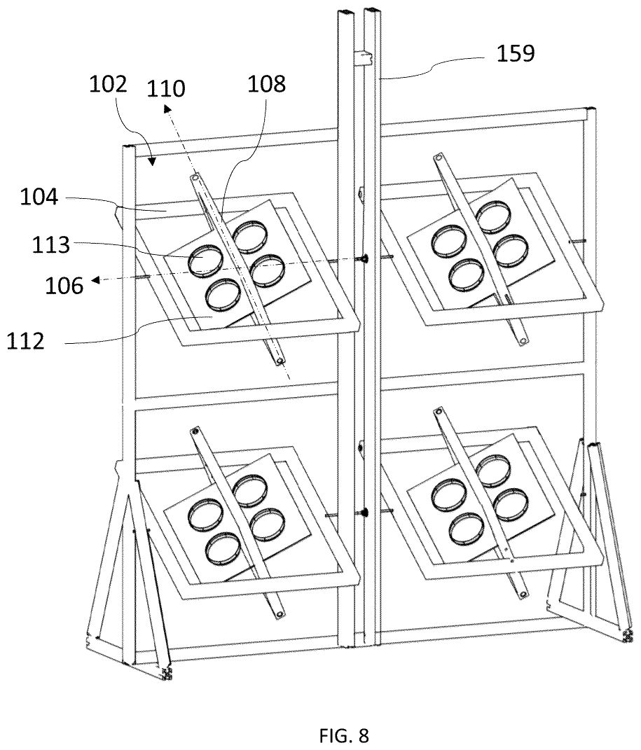

Referring to FIG. 8, there is shown a perspective view of an embodiment of a microgravity simulation system of the present patent document with multiple platforms without a drive system. The structure of a microgravity simulation system may include a plurality of platforms 102, where each platform 102 includes an outer rotating element 104 having a first end opposite a second end, where the outer rotating element 104 has a first axis 106 extending along a length from the first end to the second end. The outer rotating element 104 may be configured to rotate about the first axis 106. An inner rotating element 108 may have a second axis 110 perpendicular to the first axis 106 of the outer rotating element 104, where the inner rotating element 108 has a first end opposite a second end. In such embodiments, the inner rotating element 108 has a second axis 110 extending along a length from the first end to the second end, wherein the inner rotating element 108 may be configured to rotate about the second axis 110. The inner rotating element 108 may be disposed in an interior volume delimited by the outer rotating element 104 when the outer rotating element 104 rotates around the first axis 106. A sample station 112 may be operatively connected to the inner rotating element 108. In some embodiments, the sample station 112 may include samples 113 disposed on the surface of sample station 112. In some embodiments, a sample 113 maybe be disposed on the surface of sample station 112 at the center of the sample station 112.

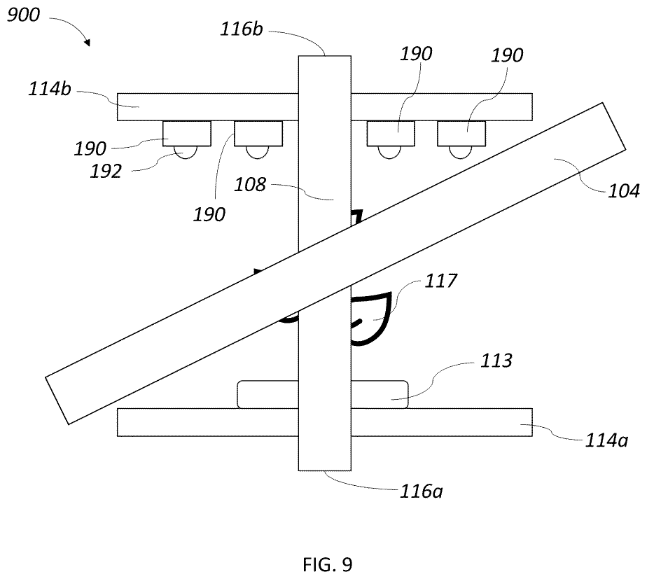

Referring to FIG. 9, there is shown a side view of an alternative embodiment of a platform of a microgravity simulation system of the present patent document. In the platform 900 shown in FIG. 9, a single sample 113 maybe be located at the center of a sample station 112, such that a plant 117 is located at the center of the sample station 112. In other embodiments, the plant 117 may be any specimen to be studied. In some embodiments, the sample 113 may be a petri dish. In some embodiments, the specimens may be watered when the microgravity simulation system is moving. In other embodiments, the specimens may be watered when the microgravity simulation system is turned off.

In some embodiments, a microgravity simulation system may be referred to as a microgravity simulation device. In certain embodiments, a microgravity simulation system may be referred to as a microgravity simulator system or a microgravity simulator device. In various embodiments, a microgravity simulation device may comprise a first rotatable element, having a first sample station, a second rotatable element, having a second sample station, and a motor operatively connected to both the first rotatable element and the second rotatable element, such that the first rotatable element and the second rotatable element are capable of operating at the same rate of rotation. In such embodiments, the first sample station and the second sample station may experience the same gravitational effects. For example, a first sample placed at a location on a first sample station of one of the first rotatable element may experience substantially the same acceleration history as a second sample placed at a corresponding location on the second sample station.

In some embodiments, a microgravity simulation system may be a 3D clinostat. In certain embodiments, a microgravity simulation system may be a random positioning machine (RPM). In some embodiments, the microgravity simulation system can simulate microgravity with light modulation capability. A microgravity simulation system with light modulation capability may be used to study the effects of light spectra on plant growth in microgravity in space.

In a preferred embodiment, the microgravity simulation system 100 may have four platforms 102. In such an embodiment, the microgravity simulation system 100 may have four outer rotating elements 104, and four inner elements 108, where all of the sample stations 112 are centered in the inner rotating elements 108 and the inner rotating elements 108 operate synchronously.

In some embodiments the platforms 102 may be referred to as rotatable frames. The microgravity simulation system may include four pairs of independently rotatable frames, where the independently rotatable frames include an outer rotating element 104 and an inner rotating element 108 coupled to the outer rotating element 104. The inner rotating element 108 may be referred to as an inner frame, and the outer rotating element 104 may be referred to as an outer frame. In some embodiments, the outer frame rotates about a fixed axis (“outer-frame axis”), and the inner frame rotates about an axis that is perpendicular to, and rotates with, the outer-frame axis. In certain embodiments, four inner frames are linked and driven by a single motor, and four outer frames are linked and driven by a second motor. In some embodiments, the sample plate may be referred to as a sample station. In certain embodiments, the outer frame, inner frame, and sample station may be referred to as a platform.

In a preferred embodiment where the microgravity simulation system includes a main structure and multiple platforms, the rotation of the outer frames for all platforms on the main structure or stand is driven synchronously by a single motor. In other embodiments, the outer frames may be individually controlled. In some embodiments, the rotation of the outer frames may be driven by different motors. In certain embodiments, the rotation of the inner frames for the platforms on the stand may be driven synchronously by a single motor. In other embodiments, the inner frames may be individually controlled. In some embodiments, the rotation of the inner frames may be driven by different motors. In an example embodiment, the inner dimensions of each outer frame may be 44.5×44.5 cm, and the inner dimensions of each inner frame may be 30.5×30.5 cm. These dimensions are by way of illustration only. The dimensions may be varied in any fashion as appropriate to the application.

The microgravity simulation system may include a support structure or stand. The support structure or other structural components of the microgravity simulation system may be made out of any suitable material, including, but not limited to, metal, plastic, or wood. By way of example, the structural components of the microgravity simulation system may include, but are not limited to, the stand 159, the outer rotating elements 104, the inner rotating elements 108, and the sample station 112. In an embodiment where the structural components of the microgravity simulation system are made of metal, the structural components of the microgravity simulation system may be made of any metal, including, but not limited to, aluminum or steel.

In a preferred embodiment, at the intersection of the two rotational axes in a sample station, there are no centrifugal effects. In certain embodiments, a sample plate may be installed perpendicular to the plane of the inner frame, along the frame's axis of rotation. In some embodiments, a sample station may be installed on the sample plate at the intersection of the rotational axes of the inner and outer frames. In such embodiments, while the infinitesimal part of the sample lying at the point of intersection of the rotational axes of the inner and outer frames experiences zero centrifugal acceleration, the centrifugal acceleration experienced by the remainder of the sample will vary linearly with distance from the point of intersection, and will be small for sample sizes and rotation rates of interest in biological research. A sample station may also be referred to as a sample holder. In certain embodiments, identical samples may be placed on both sides of a sample plate. In other embodiments, different samples may be placed on both sides of a sample plate. In some embodiments, a sample may be placed at the center of the sample plate on both sides of the sample plate.

In a preferred embodiment, the microgravity simulation system is a 3D clinostat with multiple platforms and multi-spectral light modulation capabilities. In some embodiments, the microgravity simulation system may be referred to as a 3D Multi-platform and Multi-spectral Modulated Microgravity Simulator (M4GS). The microgravity simulation systems and methods of the present patent document may be used for research relating to plant growth in microgravity and have broad application for microgravity related life science and biomedical research.

In an embodiment of a microgravity simulation system with a multi-platform design, the movements of all platforms may be exactly matched. For example, a treatment or sample placed at a given point on one platform may experience the same acceleration history as a sample placed at the same point on a different platform. This can avoid the problem of prior devices and methods where multiple samples placed on a single platform are necessarily not at the intersection of the rotational axes, where each sample experiences a nonzero time-averaged (centrifugal) acceleration.

In various embodiments, by installing multiple platforms on a single stand, linking and driving all outer frames with one motor while linking and driving all inner frames with a second motor, a microgravity simulation system can enable the achievement and maintenance of the same simulated microgravity across multiple platforms, electromechanically. This allows multiple samples to be centered at the intersection of the rotational axes. These features will enable researchers to perform, for the first time, simultaneous studies with multiple treatment conditions or replications. When compartmentation (in the case of research animals) is needed, simultaneous experiments with identical or different conditions can be performed without having to sub-divide a single platform, thus minimizing the problem of unwanted centrifugal forces when multiple samples are necessarily located away from the intersection of the rotating axes. The microgravity simulation systems and methods disclosed herein will allow for time savings and replicability, where multi-treatment experiments may be conducted simultaneously, and under precisely identical environmental conditions.

Although the embodiments have been described with reference to the drawings and specific examples, it will readily be appreciated by those skilled in the art that many modifications and adaptations of the apparatuses and processes described herein are possible without departure from the spirit and scope of the embodiments as claimed hereinafter. For example, embodiments have been described with reference to drawings and specific examples that utilize chain drives as an exemplary drive mechanism. One skilled in the art will appreciate however that other drive mechanisms may be used in lieu of, or in addition to, chain drives, including, but not limited to, belt drives (e.g., timing belts) and shaft drives (geared shafts). Thus, it is to be clearly understood that this description is made only by way of example and not as a limitation on the scope of the embodiments as claimed below.

For the foregoing reasons, the subject matter described herein provides an innovative microgravity simulation system. The current system may be modified in multiple ways and applied in various technological applications. The disclosed method and apparatus may be modified and customized as required by a specific operation or application, and the individual components may be modified and defined, as required, to achieve the desired result.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed in this specification are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the implied term “about.” The (stated or implied) term “about” indicates that a numerically quantifiable measurement is assumed to vary by as much as 30 percent, but preferably by at least 10%. Essentially, as used herein, the term “about” refers to a quantity, level, value, or amount that varies by as much 10% to a reference quantity, level, value, or amount. Accordingly, unless otherwise indicated, the numerical properties set forth in the following specification and claims are approximations that may vary depending on the desired properties sought to be obtained in embodiments of the present invention.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein. The term “an effective amount” as applied to a component or a function excludes trace amounts of the component, or the presence of a component or a function in a form or a way that one of ordinary skill would consider not to have a material effect on an associated product or process.

What is claimed is:

1. A microgravity simulation system, comprising:
a plurality of platforms, each platform comprising:
an outer rotating element having a first end opposite a second end, the outer rotating element having a first axis extending along a length from the first end to the second end, wherein the outer rotating element is configured to rotate about the first axis;
an inner rotating element having a second axis perpendicular to the first axis of the outer rotating element, the inner rotating element configured to rotate about the second axis; wherein the inner rotating element is disposed in an interior volume delimited by the outer rotating element when the outer rotating element rotates around the first axis;
wherein the outer rotating elements of each of the plurality of platforms are rotated by an outer rotating element motor.

2. The microgravity simulation system of claim 1, wherein the plurality of platforms are capable of operating synchronously.

3. The microgravity simulation system of claim 1, wherein the plurality of platforms are capable of operating independently of each other.

4. The microgravity simulation system of claim 1, further comprising:
a first sample station connected to the inner rotating element;
wherein a rotation of the outer rotating element and the inner rotating element capable of generating a simulated microgravity effect in the first sample station.

5. The microgravity simulation system of claim 1, wherein the inner rotating elements of each of the plurality of platforms are rotated by a single motor shared by the inner rotating elements.

6. The microgravity simulation system of claim 1, wherein each of the inner rotating elements of each of the plurality of platforms are rotated by a different motor.

7. The microgravity simulation system of claim 5, wherein the plurality of platforms are located on a stand that supports the plurality of platforms.

8. The microgravity simulation system of claim 7, wherein a six degree-of-freedom inertial measurement unit is disposed on the sample station.

9. The microgravity simulation system of claim 1, wherein the plurality of platforms are capable of rotating at the same rate of rotation.

10. The microgravity simulation system of claim 4, wherein the first sample station extends perpendicular to the second axis of the inner rotating element; and
wherein the first sample station is located toward a first side of the inner rotating element, and a second plate is located toward a second side of the inner rotating element, wherein the first side is opposite the second side.

11. The microgravity simulation system of claim 10, wherein the second plate has at least one lighting element.

12. The microgravity simulation system of claim 11, wherein the at least one lighting element is a multi-spectral lighting element.

13. The microgravity simulation system of claim 12, wherein the multi-spectral lighting element comprises a plurality of lights, the plurality of lights comprising at least a first light and a second light;
wherein the first light is a different color from the second light.

14. The microgravity simulation system of claim 1, wherein the outer rotating element motor is operatively connected to an outer rotating element drive shaft.

15. The microgravity simulation system of claim 14, further comprising:
a frame supporting the plurality of platforms;
a first drive chain operatively connected to the outer rotating element drive shaft; and
a first outer rotating element axle operatively connected to the first drive chain;
wherein the first outer rotating element axle is operatively connected to at least one of the outer rotating elements.

16. The microgravity simulation system of claim 15, further comprising:
an inner rotating element motor operatively connected to an inner rotating element drive shaft; and
an inner rotating element transfer shaft operatively connected to the inner rotating element drive shaft by an inner axle drive chain.

17. The microgravity simulation system of claim 16, further comprising:
a floating double sprocket operatively connected to the inner rotating element transfer shaft by a transfer shaft drive chain;
a gearbox having a gearbox input shaft and a gearbox output shaft, the gearbox input shaft operatively connected to the floating double sprocket by a double sprocket drive chain; and
an inner frame axle operatively connected to the inner rotating element, wherein the gearbox is operatively connected to the inner frame axle by a gearbox drive chain.

18. A microgravity simulation device, comprising:
a first rotatable element, having a first sample station;
a second rotatable element, having a second sample station; and
a first motor operatively connected to the first rotatable element;
wherein the first rotatable element and the second rotatable element are capable of rotating synchronously.

19. The microgravity simulation device of claim 18, wherein a second motor is operatively connected to the second rotatable element.

20. The microgravity simulation device of claim 18, wherein the first motor is operatively connected to both the first rotatable element and the second rotatable element such that the first rotatable element and second rotatable element are capable of rotating synchronously.

21. The microgravity simulation device of claim 18, wherein the first rotatable element is a first inner rotatable element, and the second rotatable element is a second inner rotatable element; and
wherein the first motor is operatively connected to both the first inner rotatable element and the second inner rotatable element such that the first inner rotatable element and second inner rotatable element are capable of rotating synchronously.

22. The microgravity simulation device of claim 21, wherein the first inner rotatable element is coupled to a first outer rotatable element, and the second inner rotatable element is coupled to a second outer rotatable element;
wherein the inner rotatable element is disposed in an interior volume delimited by a rotation of the outer rotatable element.

23. The microgravity simulation device of claim 22, wherein a second motor is operatively connected to both the first outer rotatable element and the second outer rotatable element such that the first outer rotatable element and second outer rotatable element are capable of rotating synchronously.

24. A method of simulating microgravity, comprising:
rotating an outer rotating element of each of a plurality of platforms of a microgravity simulation device; and
rotating an inner rotating element of each of the plurality of platforms, wherein the inner rotating element is disposed in an interior volume delimited by a rotation of the outer rotatable element; and
wherein a simulated microgravity effect is generated in a sample station of each of the plurality of platforms.

25. The method of claim 24, wherein the outer rotating element of each of a plurality of platforms rotate synchronously.

26. The method of claim 24, wherein the inner rotating element of each of a plurality of platforms rotate at the same rate.

27. The method of claim 24, wherein the microgravity simulation device is capable of generating the same microgravity effect in a sample station of each of the inner rotating elements.

28. The method of claim 24, wherein the microgravity simulation device further comprises at least one lighting element.

29. The method of claim 28, wherein the wherein the at least one lighting element is a multi-spectral lighting element.

30. The method of claim 24, wherein the outer rotating element of each of a plurality of platforms is rotated by a first motor shared among each of the outer rotating elements such that the first motor rotates each of the outer rotating elements synchronously; and
wherein the inner rotating element of each of the plurality of platforms is rotated by a second motor shared among each of the inner rotating elements such that the second motor rotates each of the inner rotating elements synchronously.
